(19) United States
(12) Patent Application Publication
(10) Pub. No.: US 2007/0094605 A1
(43) Pub. Date: Apr. 26, 2007

(54) System for transforming selected sections of a network, e.g. Web documents accessed from network sites, e.g. Web sites, into e-mail messages

(76) Inventors: Timothy Alan Dietz, Austin, TX (US); Walid Kobrosly, Round Rock, TX (US); Nadeem Malik, Austin, TX (US)

Correspondence Address: IBM CORPORATION, PO BOX 12195, DEPT YXSA, BLDG 002, RESEARCH TRIANGLE PARK, NC, 27709, US

(21) Appl. No.: 11/255,143

(22) Filed: Oct. 20, 2005

(51) Int. Cl. G06F 17/00; G06F 15/16; G06F 15/00

(52) U.S. Cl. 715/752; 715/530; 709/206

(57) ABSTRACT

A receiving computer controlled display terminal that has accessed and displayed a network, e.g. Web document, is enabled to select a section of the displayed Web document to designate, e.g. block off a section in the document, and to transform the designated section into an E-mail message. This E-mail message may then be sent to selected terminals on the Web.

### TECHNICAL FIELD

The present invention relates to computer managed communication networks such as the World Wide Web (Web), including network, e.g. Web documents distributed throughout the network from sources or sites, and electronic mail (E-mail) messages transmitted over such networks in a more limited distribution from user to user.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents. The Web or Internet, which had quietly existed for over a generation as a loose academic and government data distribution facility, reached “critical mass” and commenced a period of phenomenal expansion. With this expansion, businesses and consumers have direct access to all manner of documents and media distributed from Web document sources or database sites throughout the Web. Also, as a result of the rapid expansion of the Web, E-mail, which has been distributed for over 25 years over smaller private and specific purpose networks, has moved into distribution over the Web because of the vast distribution channels that are available. As a result of this expansion, extraordinary worldwide communication channels and resources have become available to businesses, academic institutions and individuals.

The network documents, e.g. Web documents including Web pages are the instruments for repetitively distributing large amounts of information from the database sources or sites on the network, e.g. Web sites. Web documents are implemented in HyperText Markup Language (HTML) language. Web or like private network documents contain highlighted hyperlinks that may be activated by users to access other Web documents from other linked Web sites. Web or like network documents contain relatively large amounts of information, and through hyperlinks embedded in such documents provide the user receiving such documents access to even greater amounts of information in the linked Web documents.

E-mail frequently uses the same distribution channels on the Web or like networks for smaller distribution of personal or business messages among senders and recipients. While E-mail and Web or like network documents very frequently use the same distribution channels, there appear to be no practical applications available involving any interchange of the contents of E-Mail messages and Web documents or Web pages. The present invention provides for such an interchange.

### SUMMARY OF THE PRESENT INVENTION

The present invention provides the user at a receiving computer controlled display terminal that has accessed and displayed a network, e.g. Web document with the ability to select a section of the displayed Web document to designate, e.g. block off a section in the document, and to transform the designated section into an E-mail message. According to the broadest aspects of the invention, a user is enabled to define a portion of the content of said displayed document, and to transform the defined portion of said document into an E-mail message. The resulting E-mail message may then be transmitted to at least one destination on the communications network. When the user defines the portion of the network document to be transformed into the E-mail message, the user is prompted to select to transform the defined portion into an E-mail message. There also may be provided at the Web document receiving computer display, a storage facility accessible to the computer controlled display for storing the received document, and means for accessing the received document from the storage facility. When the portion is defined, a new E-mail message is customarily formed. However, the transformed portion may also be incorporated into an existing E-mail message.

In accordance with another aspect of the invention, the system may be used to transmit a sequence of said electronic mail messages, with each message including a defined portion of a displayed Web document to one selected network destination. This may be done by selecting a target destination on said network, enabling the user to define portions in each of a sequence of displayed Web documents, and enabling the user to sequentially respectively transform each of the defined portions into an E-mail message so that the means for transmitting transmit the sequence of electronic messages to the target destination on the network, e.g. Web.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized view of a distribution system over an illustrative Web portion on which the received Web document portion may be transformed into an E-mail message that is then sent to a destination on the Web;

FIG. 2 is a block diagram of a data processing system including a central processing unit and network connections via a communications adapter that is capable of implementing the sending and receiving display computer terminals for receiving Web documents and sending E-mail messages, the data processing system may implement any of the Web servers shown in FIG. 1;

FIG. 3 is an illustrative generalized view of a portion of a receiving computer controlled display terminal display screen showing one page of a received Web document;

FIG. 4 is the illustrative display screen of FIG. 3 after a portion of the page has been defined, e.g. blocked off;

FIG. 5 is an illustrative generalized view of an E-mail message including the transformed portion defined in FIG. 4;

FIG. 6 is an illustrative flowchart describing the setting up of the functions to transform a defined portion of a received Web document into an E-mail message, and to send the resulting E-mail message; and

FIG. 7 is a flowchart of an illustrative run of the program set up according to FIG. 6.

### DETAILED DESCRIPTION OF THE PREFERRED EMBODIMENT

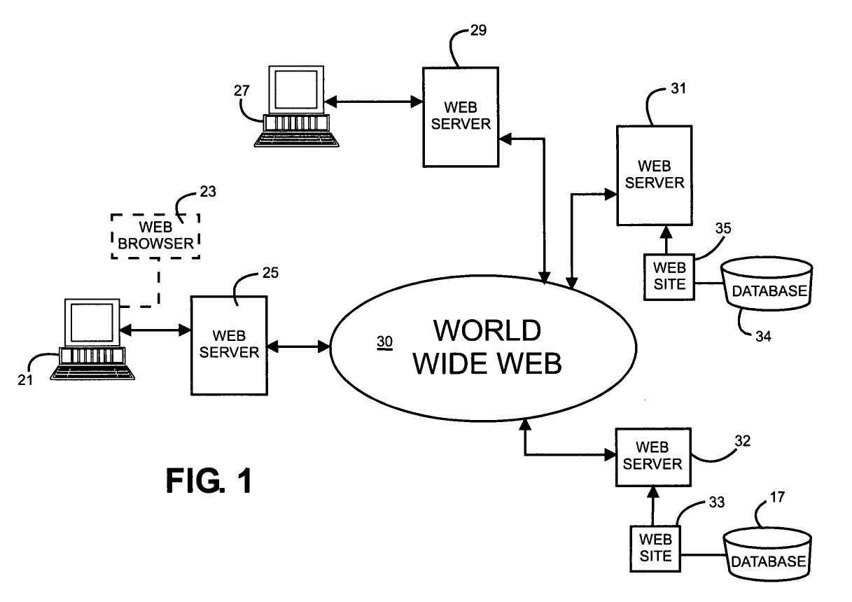

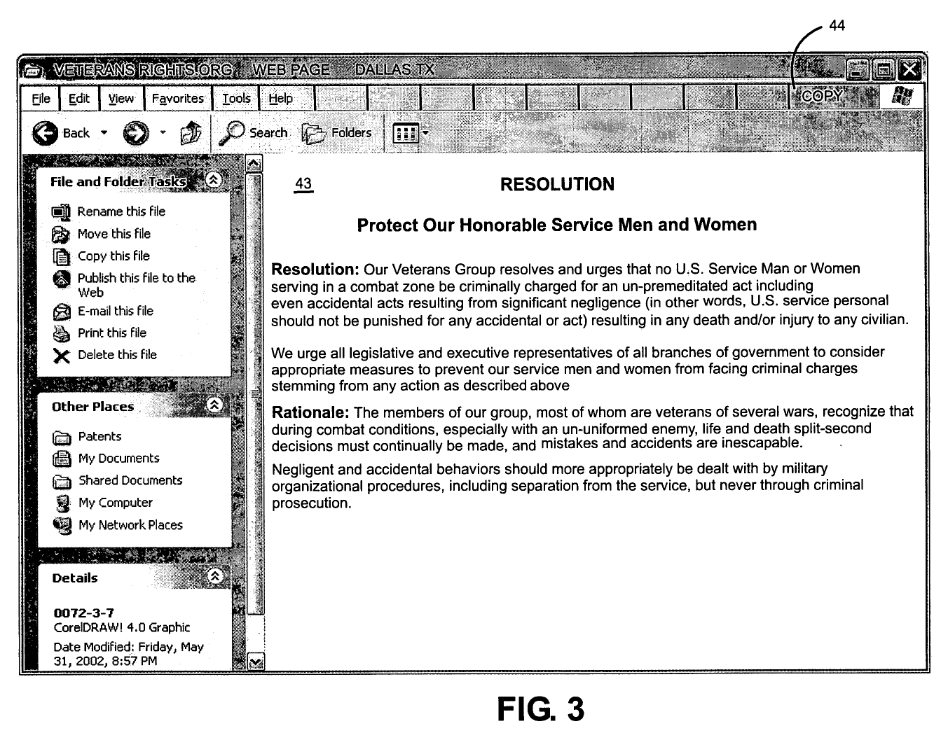

Referring to FIG. 1, there is provided a generalized distribution system over a network, such as the Internet or Web (used interchangeably), showing the elements of the system for accessing and displaying Web documents, defining portions of Web documents, and transforming such portion into an E-mail of the present invention. In the following description, it will be understood that the described elements will be controlled and initiated by a receiving user of a Web document at computer controlled display terminal 21 who then sends E-mail messages to other receiving display terminals, as will hereinafter be described in greater detail with respect to the display screen sequence of FIGS. 3 through 5.

Before going further into the details of specific embodiments, it will be helpful to understand from a more general perspective the various elements and methods that may be related to the present invention. Since the major aspect of the present invention is directed to Web documents and electronic mail transmitted over global networks, such as the Web or Internet, an understanding of such communication networks and their operating principles would be helpful. We will not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999. Any data communication system that interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers.

Web documents may be implemented in HyperText Markup Language (HTML) language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition, particularly in Chapter 19, pp. 419-454, on the Netscape Navigator; in Chapter 20, pp. 455-494, on the Microsoft Internet Explorer; and in Chapter 21, pp. 495-512, covering Lynx, Opera and other browsers.

Returning now to the details of FIG. 1, the user at receiving terminal 21, using his Web browser 23 via Web server 25 accesses Web 30 documents from Web sites, e.g. either Web site 35 or 33 respectively supported by database 34 or 17, via Web server 34 or 17. The resulting accessed Web document is displayed on computer controlled display 21. A portion of the displayed Web document is then transformed into an E-mail message, as will hereinafter be described in greater detail with respect to FIGS. 3 through 5. The resulting E-mail message may be edited further and then sent via the network to another computer controlled display terminal, e.g. display terminal 27 via Web server 25, the Web 30 and Web server 29.

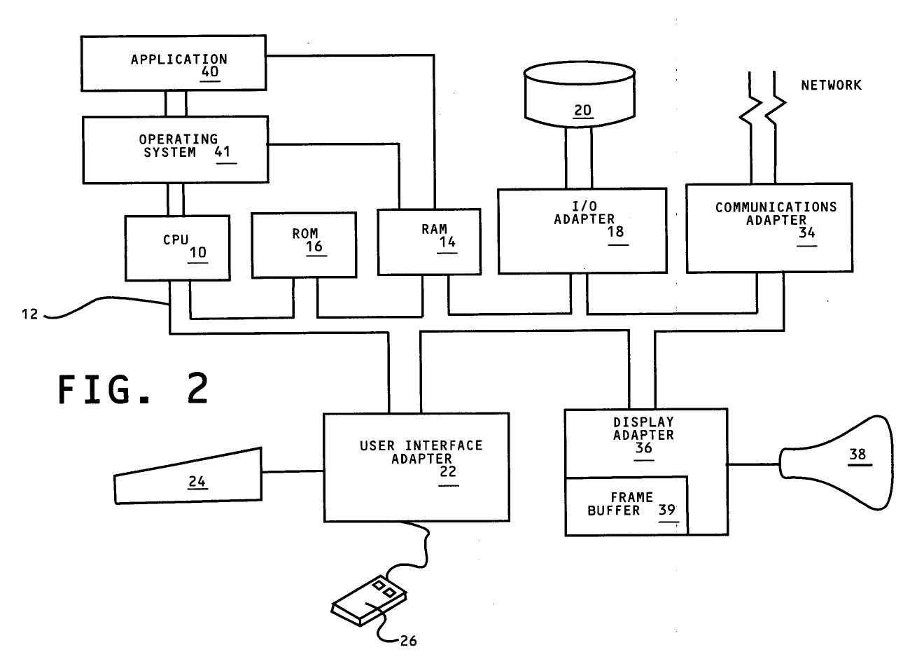

Before proceeding with a description of the computer functions used in the implementation of this invention, reference should be made to FIG. 2 that shows a typical data processing terminal that may function as a Web document receiving terminal, as well as the E-mail message sending terminal, i.e. display terminal 21, or the receiving display terminals 29 (FIG. 1) or Web servers 25, 29, 31 and 32. The data processing central processing unit (CPU) 10, such as one of the PC microprocessors or workstations, e.g. RISC System/6000™ (RS/6000) series available from International Business Machines Corporation (IBM) is provided and interconnected to various other components by system bus 12. An operating system 41 runs on CPU 10, provides control and is used to coordinate the function of the various components of FIG. 2. Operating system 41 may be one of the commercially available operating systems, such as the AIX 6000™ operating system available from IBM; Microsoft's Windows XP™, as well as UNIX and AIX operating systems. Application programs 40, controlled by the system, are moved into and out of the main memory, random access memory (RAM) 14. These programs include the programs of the present invention for selecting a portion of a displayed received Web document and transforming the portion into an E-mail that is then sent to a selected display terminal.

A read only memory (ROM) 16 is connected to CPU 10 via bus 12 and includes the basic input/output system (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the outside network enabling the data processing system to communicate as respectively described above through the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively receive or control the received Web pages and the E-mail messages being sent via the network. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

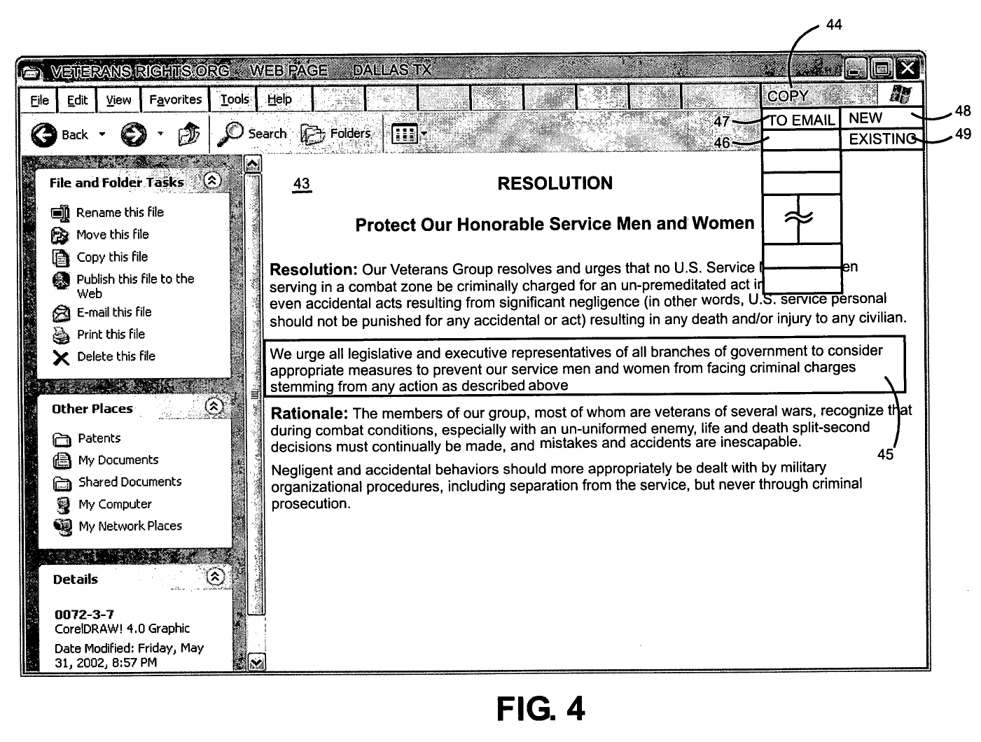

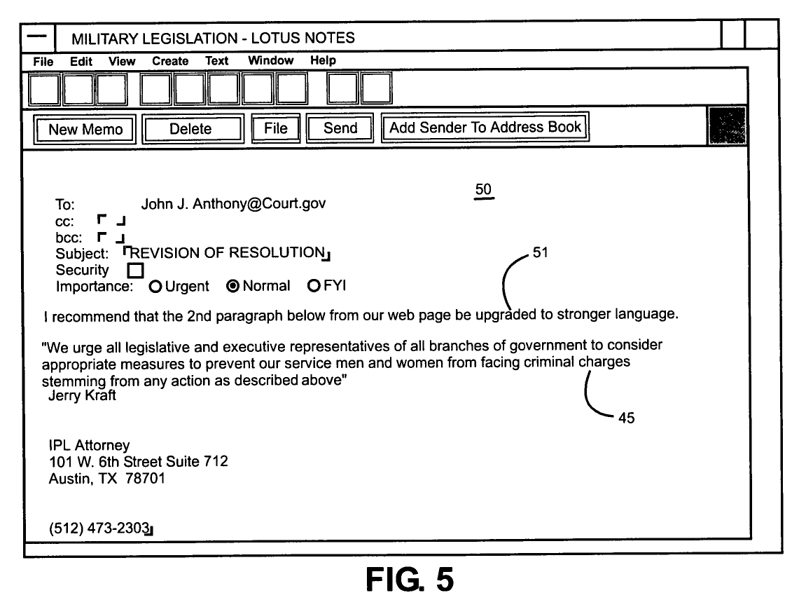

Now, with respect to the sequence of FIGS. 3 through 6, there will be described a simple illustration of the practice of the present invention wherein the user at a receiving display terminal displays a received Web document and transforms a selected portion of the document into an E-mail message that is then sent to other users at Web display stations. In FIG. 3, the interactive display screen 43 of a receiving display terminal is shown including a “RESOLUTION” to “Protect Our Honorable Service Men and Women” on a Web page. On the tool bar menu of the screen is a button 44 to initiate a copy function. In FIG. 4 in the same screen, the user has blocked out a portion 45 that he wishes to transform into an E-mail message. The user selects, clicks on “Copy” button 44. This causes menu 46 to drop down. The menu offers the user several choices for the processing of the portion 45. When the user selects “To E-Mail” 47, this results in another menu listing “New” 48 or “Existing” 49 whereby the user may select a new or existing E-Mail. Had the user selected an existing E-Mail, that E-Mail could have been retrieved from storage. However, here the user has selected a new E-mail. This results in the display of the E-Mail message 50 of FIG. 5 that is a new E-Mail Message. Portion 45 has been transformed into the E-mail message and the user has added his own comments 51 via an editing function. The E-mail message may then be sent via the network to display terminals on the network where the users are awaiting information via the message.

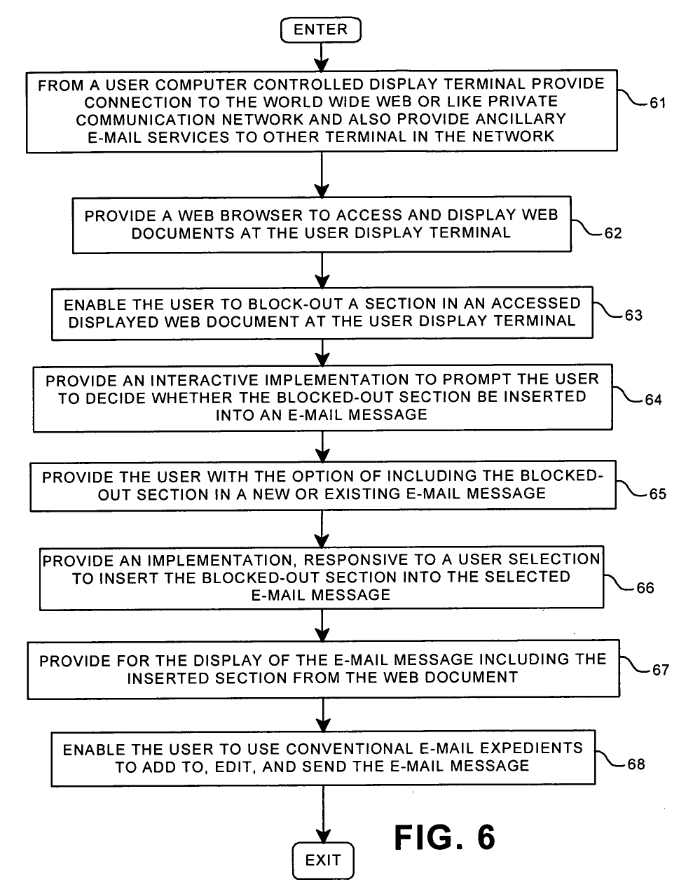

Now, with respect to FIG. 6 there will be described the programming functions that should be set up in order to practice this invention. In a network such as the Web, where a local receiving display terminal may access Web documents from Web site databases, step 61, and wherein E-mail services to other receiving terminals is also provided, provision is made for the accessing and display of Web documents through the use of a Web browser, step 62. The user is enabled to block-out a section in an accessed and displayed Web document at the receiving terminal, step 63. There is provided an interactive implementation to prompt the user to decide whether the blocked out portion should be inserted into an E_Mail message, step 64. If the choice is made to insert the blocked out portion into an E-mail message, a further option is offered to the user, i.e. whether to transform the selected portion into an existing or new E-mail message, step 65. An implementation is then provided to insert the blocked out section into the selected E-Mail message responsive to a user selection to do so, step 66. Provision is made to display the E-Mail message including the inserted section from the Web document, step 67. The user is, thus, enabled to use conventional E-mail “Add-to, Edit and Send” functions on the E-Mail message prior to sending the message to a Web terminal location, step 68.

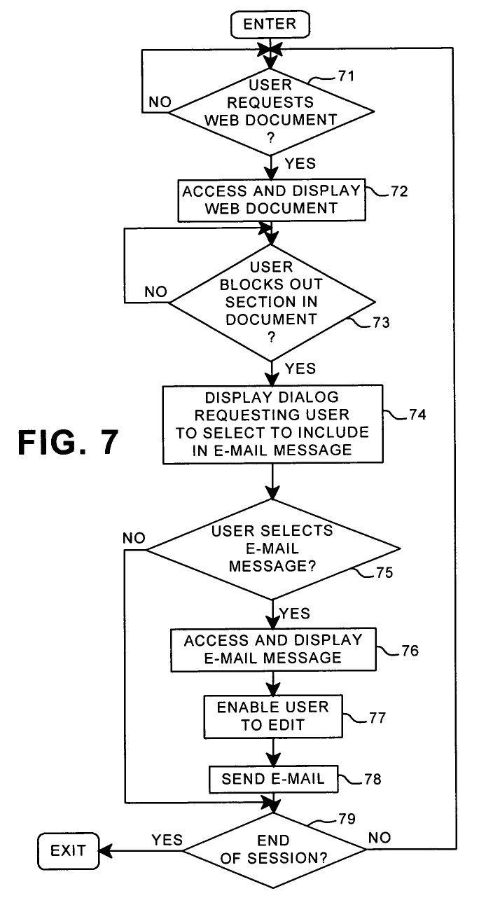

Now, with reference to the flowchart of FIG. 7 a simplified illustrative run of the process set up in FIG. 6 will be described. At a display terminal on the Web, a determination is being made as to whether the user has selected a Web document, step 71. If Yes, the accessed Web document is displayed on the receiving display terminal, step 72. Next, a determination is made as to whether the user has blocked out a portion of the displayed Web document, step 73. If No, such a selection is awaited. If Yes, then a dialog box is displayed that requests that the user select to include in an E-Mail message, step 74. Then a determination is made as to whether the user has selected to include in an E-Mail message, step 75. If Yes, then the resulting E-Mail message is displayed, step 76, the user is enabled to Edit, step 77, and the E-Mail message is sent, step 78. At this point, or if the decision in step 75 is No, a determination is made as to whether the session is over. If Yes, the session is exited. If No, the session is branched back to step 71.

It should be noted that the programs covered by the present invention may be stored outside of the present computer systems until they are required. The program instructions may be stored in another readable medium, e.g. in disk drives associated with the receiving terminals or the hub servers. The program instructions may be in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention.

One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A computer controlled display system in a communications network for transmitting a designated portion of a received network document by electronic mail to destinations on said network comprising:
means for displaying said received network document;
means enabling a user to define a portion of the content of said displayed document;
means enabling a user to transform the defined portion of said document into an electronic mail message; and
means for transmitting said electronic mail message to at least one destination on said communications network.

2. The system of claim 1 wherein said means enabling the user to transform said defined portion into said electronic mail message comprises means, responsive to said user defining a portion, for prompting said user to select to transform said defined portion into an electronic mail message.

3. The system of claim 2 wherein said network is the World Wide Web.

4. The system of claim 2 further including:
storage means accessible to said computer controlled display system for storing said existing document; and
means for accessing existing documents from said storage means.

5. The system of claim 2 wherein said electronic mail message is created responsive to said user transformation of said defined portion of said displayed document.

6. The system of claim 2 wherein said electronic mail message has been previously created, and said defined portion of said displayed document is transformed into said previously created electronic mail document.

7. The system of claim 5 further including means for transmitting a sequence of said electronic mail messages, each including a defined portion of a displayed document, to one selected network destination comprising:
means for selecting a target destination on said network;
means enabling said user to define portions in each of a sequence of displayed documents; and
means enabling the user to sequentially respectively transform each of the defined portions into an electronic mail message; wherein
said means for transmitting transmit said sequence of electronic messages to said target destination on the network.

8. In a communications network of computer controlled displays, a method for transmitting a designated portion of a received network document by electronic mail to destinations on a communications network comprising:
displaying a received network document;
enabling a user to define a portion of the content of said displayed document;
enabling a user to transform the defined portion of said document into an electronic mail message; and
transmitting said electronic mail message to at least one destination on said network.

9. The method of claim 8 wherein said step of enabling the user to transform said defined portion into said electronic mail message comprises prompting said user to select to transform said defined portion into an electronic mail message responsive to said user defining said portion.

10. The method of claim 9 wherein said network is the World Wide Web.

11. The method of claim 9 further including the steps of:
storing said existing document so as to be accessible to said computer controlled display; and
accessing said stored existing document.

12. The method of claim 9 wherein said electronic mail message is created responsive to said user transforming said defined portion of said displayed document.

13. The method of claim 9 wherein said electronic mail message has been previously created, and said defined portion of said displayed document is transformed into said previously created electronic mail document.

14. The method of claim 13 further including transmitting a sequence of said electronic mail messages, each including a defined portion of a displayed document to one selected network destination comprising:
selecting a target destination on said network;
enabling said user to define portions in each of a sequence of displayed documents; and
enabling the user to sequentially respectively transform each of the defined portions into an electronic mail message; wherein
said sequence of electronic messages are transmitted to said target destination on the network.

15. A computer program having code recorded on a computer readable medium for transmitting, by electronic mail to destinations on a communications network, a designated portion of a received network document displayed on a computer controlled display comprising:
means for displaying a received network document;
means enabling a user to define a portion of the content of said displayed document;
means enabling a user to transform the defined portion of said document into an electronic mail message; and
means for transmitting said electronic mail message to at least one destination on said network.

16. The computer program of claim 15 wherein said means enabling the user to transform said defined portion into said electronic mail message comprises means, responsive to said user defining a portion, for prompting said user to select to transform said defined portion into an electronic mail message.

17. The computer program of claim 16 wherein said network is the World Wide Web.

18. The computer program of claim 16 wherein said electronic mail message is created responsive to said user transformation of said defined portion of said displayed document.

19. The computer program of claim 16 wherein said electronic mail message has been previously created, and said defined portion of said displayed document is transformed into said previously created electronic mail document.

20. The computer program of claim 19 further including means for transmitting a sequence of said electronic mail messages, each including a defined portion of a displayed document to one selected network destination comprising:
means for selecting a target destination on said network;
means enabling said user to define portions in each of a sequence of displayed documents; and
means enabling the user to sequentially respectively transform each of the defined portions into an electronic mail message; wherein
said means for transmitting transmit said sequence of electronic messages to said target destination on the network.
